(19) United States
(12) Patent Application Publication
(10) Pub. No.: US 2013/0136678 A1
(43) Pub. Date: May 30, 2013

(54) PLATE GETTER COMPOSITES

(71) Applicant: KONSTANTIN CHUNTONOV, NESHER (IL)

(72) Inventor: KONSTANTIN CHUNTONOV, NESHER (IL)

(21) Appl. No.: 13/809,591

(22) PCT Filed: Jul. 5, 2011
(86) PCT No.: PCT/IL11/00526

§ 371 Date: Jan. 11, 2013

Related U.S. Application Data
(60) Provisional application No. 61/363,354, filed on Jul. 12, 2010.

(51) Int. Cl. B01J 20/02

(52) U.S. Cl. CPC B01J 20/0203
USPC 423/219; 264/257; 252/184; 423/210; 423/248

(57) ABSTRACT

Plate-shaped composite getter materials for the sorption of gases containing two interpenetrating constituents, a reinforcing component of skeletal framework and a reactive matrix, which form a coherent monolithic structure, a method for producing such composites, and their application in vacuum technology or gas purification are described. A synthetic getter composite of the classical type in the form of a thin monolithic plate with two constituents, a reinforcing framework embedded in a reactive matrix, has been developed. Metallic gauze made of high-melting transitional metals or their alloys is used as a reinforcing constituent and a reactive metal or alloy with a high concentration of this metal is used as the reactive matrix.

### FIELD OF THE INVENTION

The invention relates to the field of plate-shaped composite getter materials for the sorption of gases containing two interpenetrating constituents, a reinforcing agent of skeletal framework and a reactive matrix, which form a coherent monolithic structure, a method for producing such composites, and their application in vacuum technology or gas purification.

### BACKGROUND

Getter composites are gas sorbents produced by integration of essentially distinguished constituents yet maintaining their individual properties in the end product. The integration is achieved mainly by mechanical means, but may be supported by physical and/or chemical processing of the treated material. The resulting getter product thus possesses a combination of sorption characteristics that is difficult or impossible to achieve employing other technologies.

The advantages of getter composites over the traditional getters, which usually have the form of metal films, powders or porous sintered bodies of different shapes, were recognized only recently in connection with the demand for getters that are able to sorb large amounts of gas at temperatures close to room temperature. This demand appeared in several applications like small sealed—off vacuum chambers, portable analytical devices with sorption pumps, apparatuses for manufacturing super pure gases, etc.

The reason for the requirement of highly efficient getters is easy to explain: A high sorption capacity of the getter material is the condition for a long lifetime of the corresponding device or apparatus; the temperature limitations arise from the fact that some of the constructional or functional materials of the vacuum device have a low heat stability owing probably to side reactions with the formation of detrimental gases etc.

Therefore, the creation of highly effective getter composites has remained a scientific and technical challenge.

One of the first documents on getter composites [P. della Porta, C l. Boffito, L. Toia: Composite materials capable of hydrogen sorption independently from activating treatments and methods for the production thereof, WO 00/75950 (A1), 14 Dec. 2000] described both loose and consolidated metal powders, the surface of which is completely or partially covered with palladium or its alloys. Without discussing the sorption properties of these getters in any detail, it is obvious that they are the typical representatives of encapsulated materials devoid of the characteristics of composites. In fact, features typical for composites, such as the mutual chemical indifference of the constituents or their distinguished performance as a matrix and as a reinforcement are not realized. On the contrary, in the quoted cases both parts of the getter material, i. e. the core of the particle and its cover layer, consist of components which are easily alloyed together such that none of them is able to provide the material with its structural integrity. For installation in the device and for operation, extra support is required.

Materials for the purification of gas streams that have been developed in later work and presented in patents [D. Alvarez, Jr.: Method and apparatus for purification of hydride gas streams, U.S. Pat. No. 6,241,955, Jun. 5, 2001; R. Zeller, Ch. Vroman: Porous sintered composite materials, U.S. Pat. No. 7,112,237, Sep. 26, 2006] are already closer in nature to what is generally defined as a composite. The materials are generated from the clearly immiscible and mutually inert constituents: a coarsely dispersed porous base of metal, ceramic, or even a polymer serves as a substrate for a nanodispersed getter phase, consisting of metal or metal oxide particles in an intermediate oxidation state. A related material is further described in other inventions of the recent decade, e.g. in [T. Watanabe, D. Fraenkel, R. Torres, Jr. : Materials and methods for the purification of inert, nonreactive, and reactive gases, WO 03/037484 A1, 8 May 2003; D. R. Sparks, N. Najafi, B. E. Newman: Getter device, U.S. Pat. Application 2007/0205720 A1, Sep. 6, 2007, etc.].

These new generation getter materials belong to a group of multiphase porous gas sorbents according to the following peculiarities of their structure:
the new gas sorbent contains two constituents: a coarsely dispersed porous substrate and finely dispersed getter material;
the substrate is represented by a porous body, the voids of which form a system of interconnected pores open for gas diffusion;
the finely dispersed getter material is in the form of films or nanoparticles consisting of metal or metal oxide in the state of unsaturated valency;
the end product, formed by the integration of the mentioned constituents, maintains gas permeability of the substrate support due to only partial filling of the pores with the finely dispersed getter constituent, the surface of which is readily accessible to gases.

Multiphase porous gas sorbents mean a significant step forward compared to the traditional getters of highly porous sintered materials greatly excelling them in the relative sorption capacity at room temperature. However, these gas sorbents are still not ideal, their sorption capacity is far from the theoretical limit and the production technology is complicated and time consuming [T. Watanabe, D. Fraenkel, R. Torres, Jr.: Materials and methods for the purification of inert, nonreactive, and reactive gases, WO 03/037484 A1, 8 May 2003]. All the efforts put into the production of these materials are aimed at maintaining in the end product a system of free passage, letting gases enter the volume containing the active particles or films. This complicated technology is the price to be paid for the creation of a developed system of hollow channels in the getter body for gas transportation to active regions.

One more group of getter materials claimed to belong to the type of composite materials feature pellets and sheets created on the basis of the well known getter product by SAES Getters for removing gaseous contaminants from a liquid environment [R. Peterson, R. Kullberg, L. Toia, S. Rondena, J. M. Bertolo: Metal getter systems, U.S. Pat. Appl. 2009/0237861 A1, Sep. 24, 2009]. Materials of a similar composition but of a much flatter geometry have also been described [R. Kullberg, T. Armstrong, A. Conte, E. Rizzi. Flexible multi-layered getters, U.S. Pat. Appl. 2009/215610 A1, Aug. 27, 2009]. In both cases the gas sorbents are foils or pressed powder particles of transition metals or their alloys with the outside layers of the laminated material consisting at least in part of Pd in one or another concentration. In essence, these materials represent the newest modification of HPTF—strips [Brochure SAES Getters: Solution for Flat Panel Display, 2004] with all their disadvantages, mainly their extremely low relative sorption capacity at room temperature for all active gases except hydrogen.

Finally, getter solutions used for organic light emitting devices (OLED) need to be considered. These are produced in the form of monolithic multilayer sheets [J. A. Silvemail. Protected organic electronic device structures incorporating pressure sensitive adhesive and desiccant, U.S. Pat. No. 6,998,648 B2, Feb. 14, 2006]. The protection of the light emitting regions against oxygen and moisture is achieved with the help of a combination of two layers, the getter film, which chemically captures the mentioned species, and the bather layer, which blocks the diffusion of these species into the device. Although the idea of a barrier layer appeared earlier and on other occasions [N. Najafi, S. Massond-Ausari, S. Tadigadapa, Y. Zhang: Methods for prevention, reduction, and elimination of outgassing trapped gases in micromachined devices, U.S. Pat. No. 6,499,354, Dec. 31, 2002], it is in the flexible laminated structures with a thin walled shell that this idea appeared to be most relevant. The proposed [Silvemail, U.S. Pat. No. 6,998,648] highly productive roll-to-roll manufacturing technique completely satisfies the conditions for the formation of thin monolithic material without inner voids. However, here like in the previous cases the described materials are not composites but laminated materials, the layers of which are kept together simply by adhesion forces. In summary therefore, in spite of the existing demand for highly effective materials, till now all attempts to build multiphase getter structures did not lead to the creation of getters which realize the idea of getter composites and their potential. In the present invention, the solution of the problem of the construction and production of getter composites is described.

### SUMMARY OF THE INVENTION

A synthetic getter composite of the classical type in the form of a thin monolithic plate with two constituents, a reinforcing framework embedded in a reactive matrix, has been developed. Metallic gauze made of high-melting transitional metals or their alloys is used as a reinforcing constituent and a reactive metal or alloy with a high concentration of this metal is used as the reactive matrix.

The reactive metal or its alloy takes the entire free space between the wires of the gauze and performs as the getter material, while the gauze is mainly the structurally supporting component, but as required can also play the role of a hydrogen absorbent. The reactive substrate material is chosen in such a way that it does not interact with the gauze material, melts in the range of temperatures convenient for processing and contains a reactive metal with a low ionization potential and a large atomic volume. Some of the intermetallic compounds of Na and Li and many eutectics on the basis of Mg, Ca, Sr or Ba, as well as a number of solid solutions of Li satisfy this set of conditions.

The listed reactive alloys react with gases at room temperature forming on the alloy surface a layer of compounds which grows according to a linear or close to linear rate law until the entire sorption material is consumed. In the case of composites with the shape of thin plates this property leads to a unique sorption process, which allows achieving the theoretical limit in sorption capacity at a constant gettering rate. This is an extraordinary result unique to bulk getters of the type disclosed in the present invention. So far an analogous sorption performance has been demonstrated only for conventional Li or Ba getter films, which however due to the negligible mass of the film have a limited application, viz. only in small or medium sized sealed-off vacuum chambers, where the amount of sorbed residual gases in not large.

The production method for the described composite plates is simple and consists of a sequence of operations the duration of which is minutes and not hours or days as in the case of multiphase porous gas sorbents or laminated materials. The process of manufacturing of the plates comprises charging of the initial products (namely, the reactive matrix material in the form of a metal foil and the structurally reinforcing component in the form of a metal gauze) into a hermetically closed trough which acts as the melting zone, outgassing the content of this zone under vacuum, melting of the metal foil and impregnating the gauze with the melt under argon, and rapid cooling of the treated mass for solidification of the reactive matrix material. During the solidification of the melt the gauze is pressed with a small constant force between two flat horizontal walls, the lower of which is the heated bottom of the melting bath and the movable upper one is the lid and the cooler. The opposite variant is also possible, i. e. where the heat is supplied from above and removed from below.

After cooling the product in the melting zone to room temperature, the unit is opened and the product which is in the form of a reactive plate reinforced with the metallic gauze is taken out of the bath for the transfer to the casing of the end device, e. g. into a sorption pump, gas purifier, etc. The production process in general is organized in such a way that all the above listed operations are performed under argon on the common operating platform inside a glove box.

In this way, for the first time a true getter composite, meeting completely the main criteria of composite materials, has been created. Due to the reactive matrix constituent and the thin plate shape this product achieves at room temperature the maximum sorption capacity excelling in this respect all the known getter materials with similar dimensional characteristics. In contrast to the known getters summarized above, the method of production of the new true getter composites is easy, takes little time and provides the new product with significant cost advantages.

The field of application of the getter composites covers most industrial uses for getter materials referring to both vacuum technologies and to the production of pure gases. By properly combining selected constituents of the getter composite, it is easy to produce a gas sorbent capturing all the active gases, a certain set of specific gases, or finally a single active gas.

The superiority in the sorption performance of the getter composites over that of current getter products can be explained by the difference in the structure and chemical composition. Thus, different from the multiphase porous gas sorbents, the composite getter plates are monolithic and the fraction of the reactive material in them is about 50 times higher than it is possible in typical porous gas sorbents. The products according to the present invention are easier to manufacture and their sorption capacity is by one or two orders of magnitude higher. Alike, different from flexible laminated getters, which contain transition metals and at room temperature sorb only hydrogen, the getter composite plates consisting up to 50-75% of their volume of reactive materials are able to sorb any active gases. Besides, while flexible laminated getters are kept in the form of one whole body only by adhesion forces between dissimilar layers, the integrity of the getter composite plates is provided mainly by the topology of their structure, which is similar to that of reinforced concrete.

### SHORT DESCRIPTION OF DRAWINGS

FIG. 1. shows the structure of the getter composite plate.

FIG. 2. shows the reinforcing gauze with the edging

FIGS. 3A-3B. show the melting zone including FIG. 3A the stage of outgassing of the charge and FIG. 3B the stage of solidification of the melt

### DETAILED DESCRIPTION OF THE INVENTION

New composite gas sorbents in the form of thin plates can be used for gettering the residual gases in vacuum chambers or as purification material for the removal of harmful impurities from gas streams in sorption columns. The plates are installed in the corresponding device or apparatus in such a way that they are placed there parallel to each other being separated by narrow slits for passing gas.

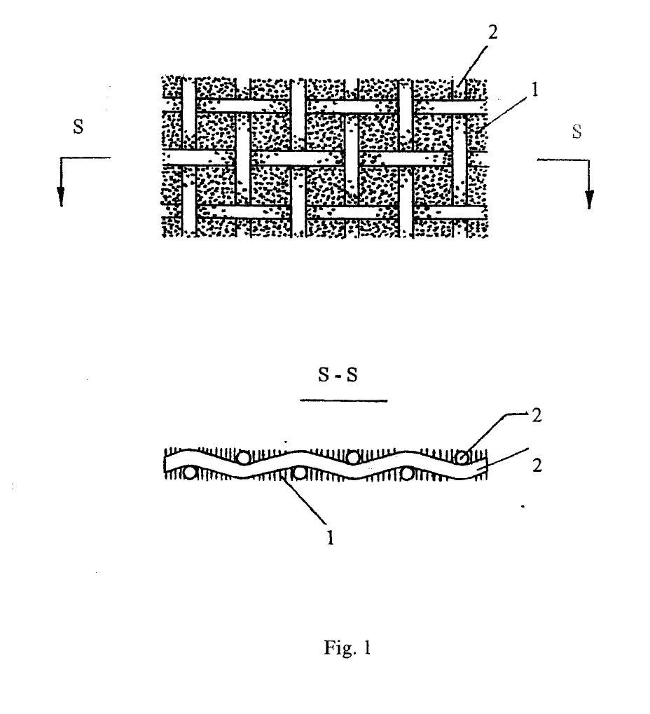

Each getter plate represents by itself a composite (FIG. 1) consisting of a reactive metal or alloy 1 and a reinforcing metal gauze 2, which is not capable to form alloys with the reactive metal. The gauze can perform not only a reinforcing and shaping function, but can also serve if necessary as a gas sorbing agent, provided that the gauze material is selected appropriately. In the present invention there are no limitations related to the mesh or gauze material, except that high-temperature transition stability is required for the metal or alloy, as e. g. with Mo, Ti, W, stainless steel, etc.

The method of integrating the constituents of a getter plate follows the classical structuring of composite materials, where the constituents are kept together not only due to adhesion forces, but mainly thanks to the mutual interlacing of two bodies. Here it is not possible to separate the composite into its constituents without physical disintegration of one of them, i. e. without applying forces, which are equal or stronger than the cohesion forces of this constituent. This means that there is a complete freedom in the choice of the pair reinforcing agent/reactive matrix, i. e. there is no need to grow transitional diffusion layers between the getter material and the substrate or to use auxiliary adhesives as applied according to the prior art.

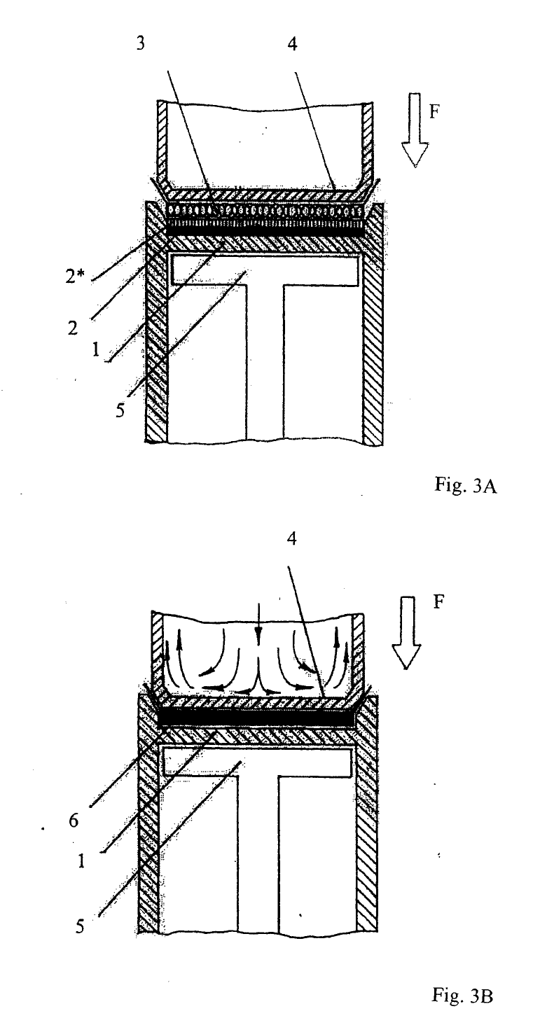

Getter composite plates are manufactured by rapid cooling of the melt filling the openings of the metal gauze, which is squeezed between the flat bottom of the trough and the flat bottom of the lid, both forming the melting and cooling zone (FIG. 3).

The foil of the reactive metal 2 or foils of several different metals (e. g. also metal 2*) and the metal gauze 3 are tightly placed on the bottom 1 (FIG. 3) of the melting bath, which is situated inside the vacuum chamber, and from above the charge is pressed with the movable lid 4. The melting zone is outgassed at a temperature of ˜250° C. and a pressure of about 10⁻⁶mbar. Thereafter it is filled with argon to 1-100 mbar and the temperature is raised until the reactive metal or several such metals are completely molten. The upper movable lid 4 is at all times in contact with the charge. Mixing of the components and impregnation of the gauze 3 with the reactive alloy or single reactive metal while the heat is applied from below takes place fast due to the small thickness of the treated mass. Subsequently, the heating from below is switched off and the lid is intensively cooled from outside in order to stimulate solidification of the reactive melt.

Solidification takes place following a steep gradient and leads to the formation of a solid product with its columnar structure oriented along the normal to the surface of the plate. The lid is moved upward and the product, the composite plate, is taken out for its installation into the casing of the end product directly on the operating platform inside the glove box under argon. Molybdenum, stainless steel or graphite is used as the material for the melting bath depending on the composition of the reactive alloy, i. e. based on the requirement of their chemical compatibility.

The thickness of the getter composites is determined by the thickness of commercially available gauze, i. e. it is generally in the range from some tens of microns to ˜1 mm, which provides a high rate of capturing active gases if reactive metals like Na, Li, Mg, Ca, Sr or Ba or their alloys are used as a matrix material. Eutectic alloys of these reactive metals are especially advantageous for the production due to the low melting temperatures of these eutectics, which for most of the given alloys fit in the temperature interval of 150-500° C. The main advantage of the getter composites of the type described here over the known getter materials is that the new products are very economic and convenient in handling. The efficiency can be explained by the fact that even at room temperature the material exploits its entire sorption potential reacting with gases to completion leaving no residual reactive metal or alloy. The relative sorption capacity of this kind of getter composites tends to unity while even in the best of the known getters this parameter can be by as much as two orders of magnitude lower. The operational performance of the getter composites is characterized by the stability of their gettering rate. The thin plate form of the composites as well as the surface growth of the products together make the reaction front move uniformly into the plate (according to a linear or close to linear kinetic law).

The technological advantages of the manufacturing process are as follows:

1. High efficiency of the production method since all operations are performed in a small closed space requiring only appropriate changes in the temperature regime of the melting zone. The flat bottom of the bath and the flat movable lid in its lower position together form a narrow plane-parallel slit zone, which is completely filled with the treated mass consisting of metallic gauze and the components of the reactive alloy. The small thickness of the treated material and its good thermal contact with the walls contribute to a rapid transfer of the system from one technological stage to the other due to the fast response to temperature and concentration gradients.

2. Minimization of losses of the sorption potential in the getter material during manufacturing. This is an important aspect of the technology as the reactive metals continuously sorb gases from the environment especially in the heated state. Therefore it is necessary to reduce the losses of reactive material during its treatment before it is installed into the casing of the end product. Simple but effective measures for lowering the contaminating influence of the gas atmosphere in the production of composite plates can be taken:
(a) reducing the treatment time by a frontal heat removal from or heat input into the bodies of thin plate shape, i. e. by typically using bodies of small size for the processes of heat transfer and diffusion;
(b) reducing of the treatment temperature by choosing matrix materials with low melting temperatures, e. g. by using eutectics;
(c) reducing of the amount of gases directly contacting the surface of the treated material and also reducing the area of its surface to the small area on the periphery of the plate (side surface);
(d) using foils of reactive metals as the initial components and not any previously prepared alloy, as it has been learnt from experience that elementary metals withstand corrosion in the neutral atmosphere of a glove box better than their alloys.

In the present invention, i. a. four prominent new getter products are presented:
composite plates on the basis of Ti gauze, impregnated with lithium metal;
composite plates containing a reactive alloy of the composition Ba—(35±2) at % Mg, reinforced by stainless steel gauze;
composite plates containing a reactive alloy of the composition Ca—(35±2) at % Al, reinforced by stainless steel gauze;
composite plates containing a reactive alloy of the composition Mg—(14.5±1.5) at % Cu, reinforced by Nb or stainless steel gauze,

These getters are covered by the above description and are typical examples for composites, each of which meets certain practical needs and illustrates the general method of composing getter composite plates.

The first product, getter plates based on Ti gauze with a reactive matrix of elemental lithium is intended for the purification of N₂ streams at or close to room temperature from all more reactive gas species: in this material the wire of Ti gauze sorbs hydrogen, while lithium reacts with the remainder of the gases forming the compounds Li₂O, Li₂C₂ , LiOH, etc.

The outgassing process is performed at ≃150° C. and the impregnation of the Ti gauze with lithium is carried out at ˜250° C. under argon at a pressure around 1 mbar. In this case there is no need for a thermal activation of the titanium metal since molten Li reduces the outer layer of the passivated Ti wire [Liquid Alkali Metals, Proc. Int. Conference, British Nuclear Energy Society, London, 1976, pp. 31-35, 219-222]. Lithium foil used in the production of getter composites is made in the glove box by flattening and cutting out a suitable part from a piece of lithium metal directly before charging the bath with the materials.

The second product,—composite plates on the basis of Ba—(35±2) at % Mg reinforced by stainless steel gauze—is among the best getters, capable to sorb all active gases at room temperature. The thickness of the plates can be brought to 2-3 mm by placing several stainless steel gauzes one upon the other, with the thickness of the barium and magnesium foils increased accordingly. The preferable temperature regime for the impregnation of the stainless steel gauze is ˜450° C., with the argon pressure at about 10 mbar.

Getter composites of this second type can be used for the purification of streams of inert gases from all active impurities, or in vacuum chambers for capturing large amounts of residual gases.

The third and fourth products are prepared for cases where a selective sorption of one gas or of a small group of gases is required. In many technologies, where glass, ceramics or polymers are heated in vacuum, a lot of moisture and hydrogen is released and has to be removed. In this context, the problems of capturing gaseous hydrogen in solar energy collector systems are also relevant [M. Barkai, S. Klapwald, Y. Schwartzman, E. Mandelberg, R. Ezer, U.S. Pat. No. 6,832,608, Dec. 21, 2004; C. Benvenuti, U.S. Pat. Application 2007/009611 A1, Feb. 22, 2007] as well as those in liquid hydrogen tanks, where hydrogen diffusing through the wall of the source gets into the vacuum space surrounding this source deteriorating its heat-insulating properties.

There are also other specific needs, e. g. the demand for an anhydrous oxygen atmosphere in order to provide long-term safety for organic products or metallic materials. Getter composites on the basis of calcium and magnesium alloys serve exactly these purposes. Composite plates with calcium eutectics Ca—(35±2) at % Al are produced in essentially the same way as the composites with the barium eutectic, but the temperature for the impregnation of the stainless steel gauze is in this case by ˜200° C. higher. Due to the high chemical affinity of calcium to oxygen and water vapor, these composites are the most potent sorbents for oxygen and moisture. If necessary, these getter plates can be isolated from the other parts of the device by a gas permeable partition or shell. If the appearance of secondary hydrogen cannot be tolerated, the getter plates should be oxidized beforehand to some degree according to the technology described previously [K. Chuntonov, Pat. Application WO 2009/053969 A2, Apr. 30, 2009]. At high degrees of oxidation the getter plates predominantly turn into desiccants capable of removing large amounts of moisture from gas mixtures. Composite plates containing a matrix alloy of the composition Mg—(14.5±1.5) at % Cu are intended for sorption of gaseous hydrogen. The matrix alloy consists of two phases: crystals of the intermetallic compound CuMg₂, which is like Mg₂Ni one of the best hydrogen sorbents, and crystals of Mg, which protect the phase CuMg₂ from oxidation.

Composite plates are manufactured following the general production scheme by impregnation of stainless steel gauze with the eutectic alloy Mg—(14.5±1.5) at % Cu and its subsequent rapid solidification. Like in the case with a Ca—containing component, here also variations of the composition and structure of the product are possible. If the rate of the hydrogenation in the plates with the eutectic alloy appears to be insufficient, it can be increased by increasing the surface area available for sorption. For this purpose the concentration of copper in the matrix material is increased to 25-30 at % by subjecting the plates themselves to a sublimation treatment in vacuum for evaporation of some of the magnesium contained in the matrix alloy as one of its constituents. This evaporation in a vacuum generates channels in the body of the getter material leading from the volume of the plate to its surface or vice versa [see K. Chuntonov, U.S. Pat. Application 2006/0225817 A1, Oct. 12, 2006], which increases the rate of purification of gas mixtures from hydrogen.

### DESCRIPTION OF THE DRAWINGS

FIG. 1 shows the view of the getter composite from above and in cross section. Here 1 is the reactive matrix material, 2 is the metallic gauze. For the reinforcement constituent not only woven wire mesh as shown in the figure can be used, but also other types of high porosity supports, e. g. porous sintered powder materials conventionally used in various filters. It is also clearly seen from this figure that the mechanical strength of the getter composite is determined not so much by adhesion forces between its components but mostly by the cohesion forces of its constituents.

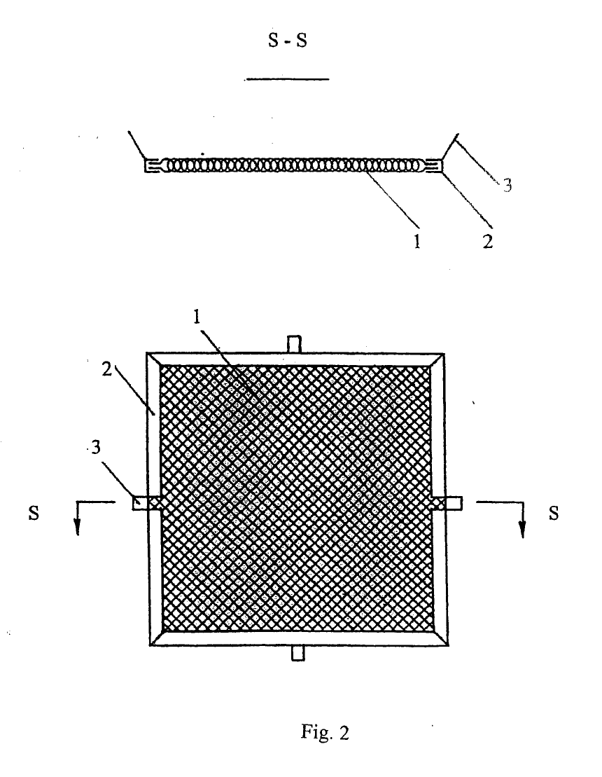

The thickness of the composite plates is determined by and similar to the thickness of the gauze, while the total configuration of the plates can be of any kind, but corresponds to the shape of the melting zone. The edges of the plates are either free or have an edge cover or frame as shown in FIG. 2.

FIG. 2. The reinforcing gauze with the edging. Here 1 is the gauze, 2 is a metal frame, 3 are auxiliary attachments.

The frame 2 lends additional strength to the gauze 1, and the attachments or ends 3 make the handling easier when the gauze is immersed into or the product taken out from the melting zone. The ends can later be cut off completely or partially if they are not used in the assembly of the getter device.

FIGS. 3A and 3B illustrate the processes taking place in the melting zone. It demonstrates a particular case when heating is carried out from below and cooling is carried out from above. Here 1 is the bottom of the bath, 2 is the foil of the reactive metal, 2* is the foil of an optional second reactive matrix component, 3 is the gauze, 4 is the movable lid, 5 is the heater, 6 is the gauze integrated in the melt, F is the pressing force.

At the stage of outgassing (FIG. 3A) the slit along the perimeter of the space between the bottom and the lid is big enough to allow the exiting of gases. When the level of ˜10⁻⁶ mbar is reached in the chamber the temperature is raised until the liquid phase appears. Under the influence of a small but constant force F the formed melt is pressed into the openings of the gauze and this change in volume is clearly indicated by the lowering of the level of the lid 4. After a short exposure of the system to the heated state, an abrupt cooling of the melt is started (FIG. 3B), for which the heater 5 is switched off and simultaneously a strong flow of the cooling agent is directed onto the outer side of the lid 4. The quenching and further cooling of the product to room temperature takes only a few minutes due to the small thermal inertia of the whole system.

1. A synthetic getter composite in a form of a thin plate containing two interpenetrating constituents, a structurally reinforcing agent and a reactive matrix, which together form a monolithic structure inseparable owing to inherent cohesion forces.

2. The synthetic getter composite according to claim 1, wherein the structurally reinforcing agent is a metallic gauze made of a refractory transition metal or alloy selected from the group consisting of Mo, Ti, W and stainless steel, and the reactive matrix is a reactive metal or its alloy, which penetrates and fills all free spaces of the metallic gauze, but does not alloy with the metallic gauze.

3. The synthetic getter composite according to claim 2, wherein the metallic gauze has the thickness from some tens of microns to ˜1 mm, and the reactive matrix is a reactive metal selected from the group consisting of Na, Li, Mg, Ca, Sr and Ba, or an alloy with a high concentration of at least one of these metals.

4. The synthetic getter composite according to claim 3, wherein Ti gauze is the structurally reinforcing agent and Li metal is the reactive matrix.

5. The synthetic getter composite according to claim 3, wherein stainless steel gauze is the structurally reinforcing agent, and eutectic alloy Ba—(35±2) at % Mg is the reactive matrix.

6. The synthetic getter composite according to claim 3, wherein stainless steel gauze is the structurally reinforcing agent and eutectic alloy Ca—(35±2) at % Al is the reactive matrix.

7. The synthetic getter composite according to claim 3, wherein Nb or stainless steel gauze is the structurally reinforcing agent and eutectic alloy Mg—(14±1.5) at % Cu is the reactive matrix.

8. A method of manufacturing getter composites according to claim 1, including:
charging of the components according to claim 1 into a melting bath;
preparation of a reactive melt and impregnation of a metallic gauze with the reactive melt in the melting bath by heating under argon and at a pressure from 1 to 100 mbar;
rapid cooling of the melting bath for solidification of the reactive matrix.

9. The method according to claim 8, wherein the melting bath consists of a lower part with a flat bottom and a flat movable lid, which together leave a thin narrow plane-parallel slit to be filled by treated getter mass.

10. The method according to claim 9, where the movable lid of the melting bath is pressed with a small constant force onto the treated getter mass.

11. The method according to claim 9, wherein the heating or cooling of the melting bath is performed by heat application or heat removal from the bottom and the movable lid, respectively.

12. A process of gas sorption at room temperature by plate getter composites according to claim 1 installed in casing of a getter pump or a gas purifier for maintaining vacuum or providing a pure gas environment.

13. The process according to claim 12, wherein a plate getter composite with a stainless steel gauze and a Ba—(35±2) at % Mg matrix is used in sorption pumps for maintaining vacuum or in sorption columns for removing all active gas impurities from a stream of a noble gas.

14. The process according to claim 12, wherein a plate getter composite with a Ti gauze and a Li matrix is used in sorption columns for purification of nitrogen streams from active impurities.

15. The process according to claim 12, wherein a plate getter composite with a stainless steel gauze and a Ca—(35±2) at % Al matrix is used for removal of oxygen and water vapor from gas mixtures.

16. The process according to claim 12, wherein a plate getter composite with a Nb or stainless steel gauze and a Mg—(14±1.5) at % Cu matrix is used for removal of hydrogen from gas mixtures.
